(19) United States
(12) Patent Application Publication
(10) Pub. No.: US 2009/0246395 A1
(43) Pub. Date: Oct. 1, 2009

(54) COATING METHOD AND COATING DEVICE

(75) Inventors: Yasuhito NARUSE, Haibara-gun (JP); Atsushi Ooshima, Haibara-gun (JP); Nobuyuki Sone, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/409,870

(22) Filed: Mar. 24, 2009

(30) Foreign Application Priority Data
Mar. 25, 2008 (JP) 2008-078333

(51) Int. Cl. B05D 1/28; B05C 1/08

(52) U.S. Cl. 427/428.06; 118/258

(57) ABSTRACT

The present invention provides a coating method and a coating device that can both prevent the occurrence of streaks and nonuniform application. A coating device comprises an approximately cylindrical bar arranged to come into contact with a traveling web, and a feed device that feeds coating solution to the entry side of the web relative to the bar. Spiral grooves inclined at an angle of 20 degrees to 70 degrees (both inclusive) with respect to a plane orthogonal to the central axis of the bar, and smooth portions with which the web comes into contact at a percentage of 20% or more are formed on the surface of the bar.

### BACKGROUND OF THE INVENTION

1. Field of the Invention

The present invention relates to a coating method and a coating device, particularly a coating method and a coating device that form beads of coating solution and coat a strip-shaped material traveling continuously with the coating solution, in manufacturing photographic film, photographic paper, magnetic recording tape, adhesive tape, pressure sensitive paper, offset plate material, batteries, and the like.

2. Description of the Related Art

Bar coating is known as a method of coating a long flexible support (hereinafter referred to as a web) traveling continuously with coating solution. In bar coating, a web is coated by bringing the web into contact with an approximately cylindrical bar, feeding coating solution upstream of the bar to form a coating bead, and rotating the bar to scrape up the coating solution in the coating bead to coat the web.

A great technical problem of this bar coating is the formation of fine streaks uniformly spaced on the coated surface in the traveling direction of the web. This is a phenomenon that has long been known in coating in which the bar is rotated at the same speed as the web, and various methods have been proposed to prevent this problem. For example, there is a known method that prevents the occurrence of streaks by rotating the bar in a direction opposite to the traveling direction of the material to be coated. In addition, Japanese Patent Laid-Open No. 7-31920 describes a method that prevents the occurrence of streaks by means of the shape of grooves formed on the surface of the bar. In addition, Japanese Patent Laid-Open No. 2001-104852 describes a coating method that uses a roll on which inclined grooves of a gravure pattern are formed.

### SUMMARY OF THE INVENTION

However, it is difficult to completely prevent the occurrence of the streaks mentioned above by using any of the conventional techniques. Moreover, another problem is that the prevention of the occurrence of the streaks causes nonuniform coating of the coated surface.

In view of these circumstances, the present invention has been made and an object of the invention is to provide a coating method and a coating device that can both prevent the occurrence of streaks and nonuniform coating.

To achieve the object, according to the first aspect of the present invention, a coating method for applying coating solution to a material to be coated includes: feeding the coating solution on an entry side of a traveling material relative to an approximately cylindrical bar; forcibly providing a flow in a transverse direction of the traveling material to the coating solution when the coating solution passes from the entry side of the traveling material to an exit side relative to the bar; coating the traveling material with the coating solution by bringing the bar into contact with the traveling material.

The inventors have found that the occurrence of streaks can be prevented by forcibly providing a flow of the coating solution in the transverse direction when the coating solution flows from the entry side to the exit side. The coating method has been made based on this finding and can prevent the occurrence of streaks because the method can provide a flow of the coating solution in the transverse direction.

According to a second aspect of the present invention, in the coating method according to the first aspect, the flow of the coating solution in the transverse direction is given by spiral grooves formed on a surface of the bar, the spiral grooves are inclined at an angle of 20 degrees or more and 70 degrees or less with respect to a plane orthogonal to a central axis of the bar, and the traveling material comes into contact with smooth portions of the bar excluding the spiral grooves at a percentage of 20% or more.

As in the second aspect, the occurrence of both streaks and nonuniform coating can be prevented by using a bar whose spiral grooves are inclined at an angle of 20 degrees to 70 degrees (both inclusive) and whose smooth surface comes into contact with the traveling material at a percentage of 20% or more.

According to a third aspect of the present invention, the coating method according to the first aspect or the second aspect, further includes rotating the bar so as to feed the coating solution around the bar. In the coating method according to the third aspect, since the coating solution is fed around the bar by rotating the bar, the bar can certainly provide a flow in the transverse direction of the coating solution. The coating solution may be fed around the bar by using a solution delivery device or the like.

To achieve the object mentioned, a coating device according to a fourth aspect of the present invention includes: an approximately cylindrical bar arranged to come into contact with a traveling material to be coated; a feed device which feeds coating solution to an entry side of the traveling material relative to the bar; and channels formed on a surface of the bar for dividing the coating solution fed to the entry side of the traveling material into smaller portions in the transverse direction of the traveling material and letting the portions flow through the channels.

The coating device can prevent the occurrence of streaks on the coated surface because the channels formed on the surface of the bar can force the coating solution to flow in the transverse direction.

According to a fifth aspect of the present invention, the coating device according to the fourth aspect further includes: spiral grooves formed on the surface of the bar, as the channels, inclined at an angle of 20 degrees or more and 70 degrees or less with respect to a plane orthogonal to a central axis of the bar; and smooth portions formed on the surface of the bar with which the traveling material comes into contact at a percentage of 20% or more.

In the coating device according to the fifth aspect, the occurrence of both streaks and nonuniform coating can be prevented by forming grooves inclined at an angle of 20 degrees to 70 degrees (both inclusive) on the surface of the bar and smooth portions which come into contact with the material to be coated at a percentage of 20% or more.

Accordingly, any one of the aspects of the present invention can prevent the occurrence of streaks on the coated surface because the invention forces the coating solution to flow in the transverse direction. Thus, the material can be coated with coating solution with high precision.

### BRIEF DESCRIPTION OF THE DRAWINGS

FIG. 1 is a schematic sectional view of the configuration of the coating device;

FIG. 2 is a side view of the bar shown in FIG. 1;

FIG. 3 is a partially enlarged sectional view of the bar shown in FIG. 2;

FIG. 4 is a table showing the conditions and results of the Examples; and

FIG. 5 is a table showing the conditions and results of the Examples.

### DETAILED DESCRIPTION OF THE PREFERRED EMBODIMENTS

Preferable embodiments of the coating method and the coating device according to the present invention are described below in accordance with attached drawings.

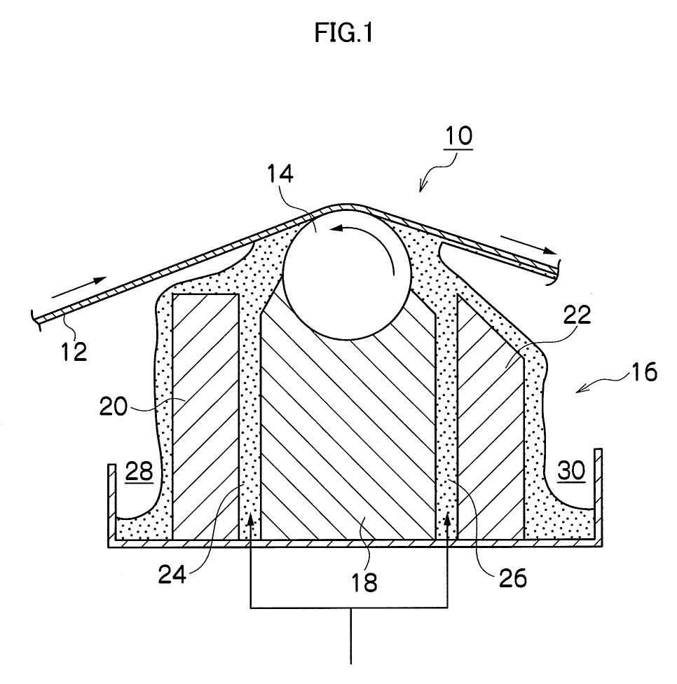

FIG. 1 is a schematic sectional view of an example of a coating device to which the present invention is applied. The coating device 10 shown in the figure is a device that applies coating solution to a web 12 (corresponding to a material to be coated) traveling continuously, and comprises a coating head 16 having a bar 14. The web 12 is wrapped by a guide roller (not shown in the figure) and brought into contact with the bar 14 at a defined wrap angle as well as travels in the direction of the arrows.

The coating head 16 consists of the approximately cylindrical bar 14 and a supporting member 18 that supports the bar 14. Arc-shaped grooves are formed on the top of the supporting member 18 and support the bar 14. The bar 14 is connected to a rotating device (not shown in the figure), which rotates the bar 14 in the direction opposite to the traveling direction of the web 12 or in the traveling direction of the web 12. When the bar 14 is rotated in the traveling direction of the web 12, the rotational speed of the bar 14 is preferably lower than the traveling speed of the web 12. The preferable rotational speed of the bar 14 is for example about 10 to 300 rpm.

With respect to the supporting member 18, a weir 20 is provided upstream of the traveling direction of the web 12 and a weir 22 is provided downstream of the traveling direction of the web 12. A slit 24 is formed between the supporting member 18 and the weir 20, and a slit 26 is formed between the supporting member 18 and the weir 22. A tank (not shown in the figure) is connected to these slits 24 and 26 and the coating solution is delivered from the tank to the slits 24 and 26. This coating solution forms beads upstream (primary side) and downstream (secondary side) of the bar 14, are measured out by the bar 14, and are applied to the web 12.

A solution reservoir 28 is provided upstream of the weir 20, and a liquid reservoir 30 is provided downstream of the weir 20. Excess coating solution is collected into these solution reservoirs 28 and 30. Exhaust lines (not shown in the figure) are connected to the solution reservoirs 28 and 30. The viscosity and surface tension of the coating solution discharged via these exhaust lines is adjusted and then the adjusted coating solution is fed again to the slits 24 and 26. The viscosity or the surface tension of the coating solution may be adjusted to a viscosity suitable (for example, 1 to 500 mPa·s, preferably 1 to 50 mPa·s) or a surface tension suitable (for example, 30 to 60×10 μN/cm) for the coating solution flowing in spiral grooves 32, which are described later.

In addition, the configuration of the coating head 16 is not limited to the configuration mentioned above, and can have variations such as the slit 24 alone provided upstream and two or more slits provided upstream. Moreover, FIG. 1 is an example in which the upper edge of the weir 20 has a flat shape and the upper edge of the weir 22 has a wedge shape, but the shapes of the upper edges of the weirs 20 and 22 are not limited to these shapes.

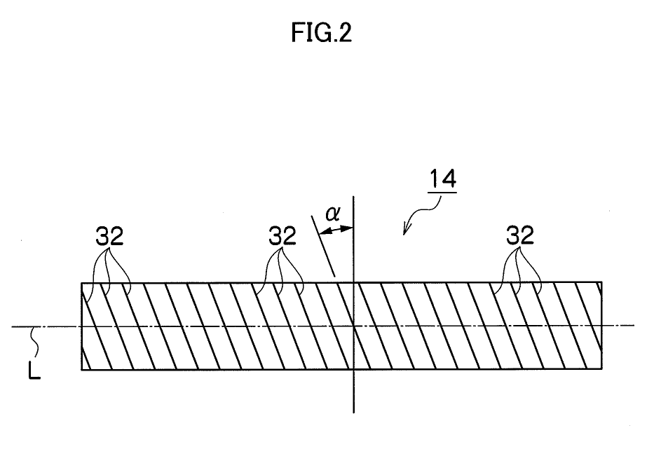

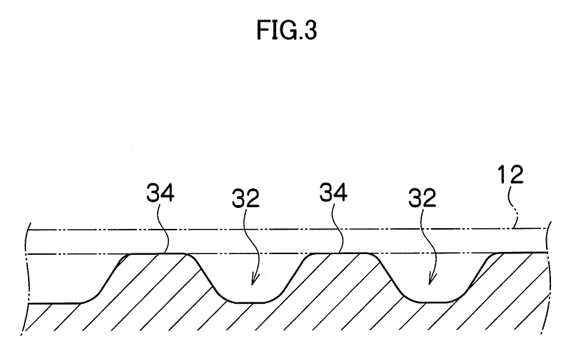

Next, the surface shape of the bar 14 which is a characteristic portion of the present invention is described. FIG. 2 is a front view of the bar 14. FIG. 3 is an enlarged sectional view of the surface of the bar 14.

As shown in these figures, multiple spiral grooves 32 are formed on the peripheral surface of the bar 14. These spiral grooves 32 are formed in a spiral and continuous way. Further, the spiral grooves 32 are formed at an angle of α with respect to a plane orthogonal to the central axis L of the bar 14. The angle α is preferably 20 degrees to 70 degrees (both inclusive), more preferably 30 degrees to 65 degrees (both inclusive). This is because any angle a smaller than the angle range causes streaks while any angle α larger than the angle range causes nonuniform coating.

In addition, the spiral grooves 32 are formed at constant intervals, and the peripheral surface is left as it is as smooth portions 34 between neighboring spiral grooves 32. In other words, each smooth portion 34 is formed between two neighboring spiral grooves 32 on the peripheral surface of the bar 14. The web 12 is brought into close contact with the smooth portions 34 when the web passes over the bar 14. Here, the web 12 comes into contact with the smooth portions 34 at a contact percentage of preferably 20% or more, particularly preferably 20% to 70% (both inclusive). This is because if the contact percentage goes beyond the range, streaks are likely to occur.

Next, a description of how the coating device 10 configured as above acts is given below.

The coating solution output through the slits 24 and 26 forms the primary bead upstream of the bar 14 and the secondary bead downstream of the bar 14. When the coating solution flows from the primary side to the secondary side, the coating solution is forced to move in the transverse direction by the grooves 32 of the bar 14. The formation of streaks in the traveling direction of the web 12 on the coated surface can be prevented by forcibly creating and controlling such a coating solution flow.

The coating device 10 of this embodiment in which the spiral grooves 32 are formed on the surface of the bar 14 can prevent the occurrence of streaks on the coated surface of the web 12 because the spiral grooves can force the coating solution to flow in the transverse direction.

In addition, the present embodiment can prevent the occurrence of both streaks and nonuniform coating because the angle α of the spiral grooves 32 with respect to the central axis of the bar 14 is 20 degrees to 70 degrees (both inclusive) and the web 12 is allowed to come into contact with the smooth portions 34 of the bar 14 at a percentage of 20% or more.

### EXAMPLES

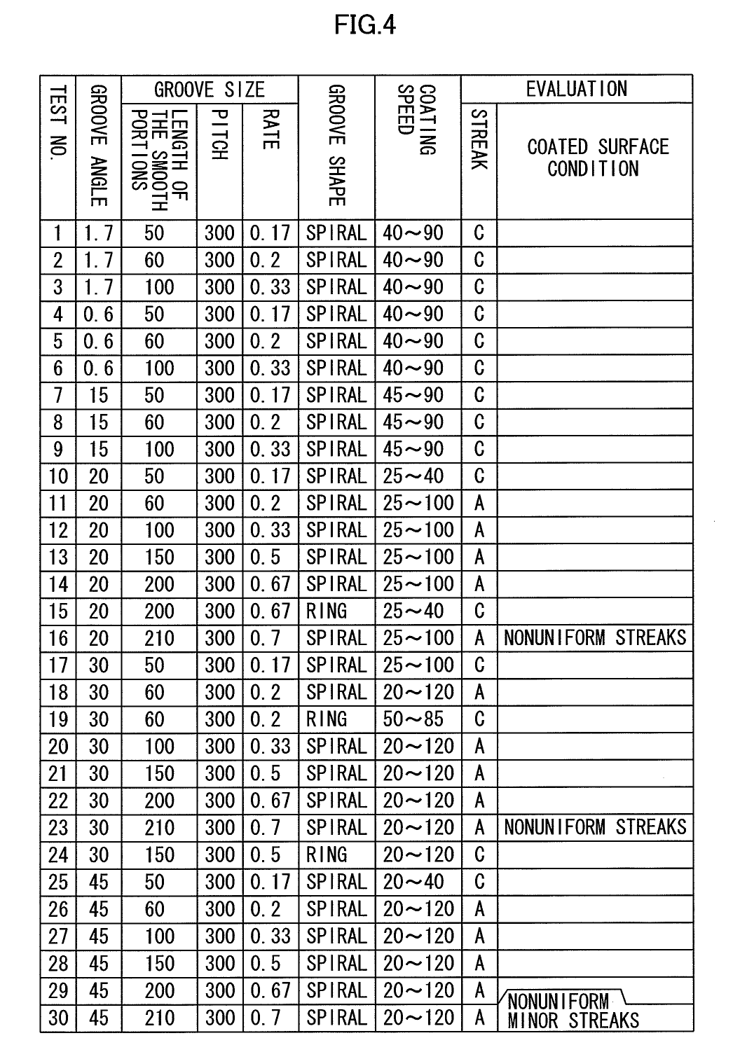

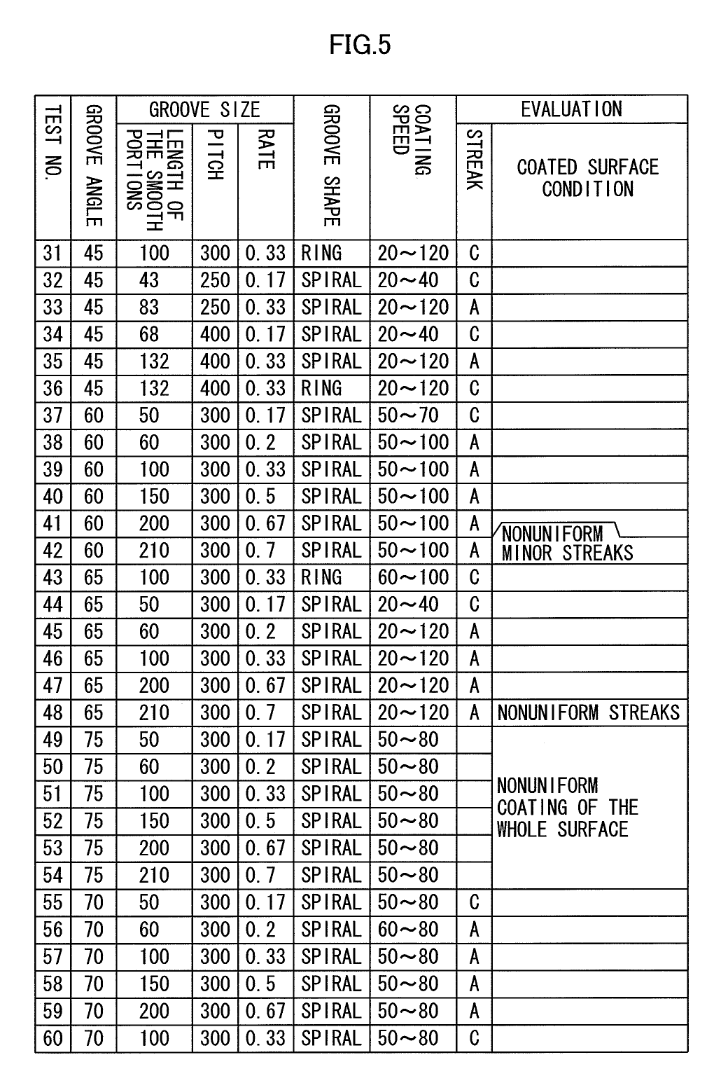

The solid content of acrylic copolymer solution using ethylene glycol monomethyl ether, methanol, and methyl ethyl ketone as solvents was varied to prepare coating solution, which was then applied onto PET films at predetermined coating speeds. The bar was rotated at 10 to 100 rpm in the traveling direction of materials to be coated (PET films). The testing was conducted under different bar conditions at a different coating speed for each test number. The coated surfaces obtained were evaluated by examining them for any streaks uniformly spaced and the condition of the coated surfaces. FIGS. 4 and 5 show the conditions of the bar, the coating solution, and the coating speeds along with evaluation results. In FIGS. 4 and 5, “Groove angle” indicates the angle α (degrees) mentioned above, “Length of the smooth portions” indicates the length [μm] of the smooth portions in the transverse direction, “Pitch” indicates the pitch [μm] between two neighboring spiral grooves, “Rate” indicates the rate at which the film comes into contact with the smooth portions, “Groove shape” indicates whether the grooves on the bar surface are spiral or ring-shaped. In addition, “Coating speed” indicates the traveling speed of the film [m/min], more specifically the range of speed at which the film was allowed to travel for evaluation. “Streak” is expressed by the letter A if there are no streaks and the letter C if there are streaks. “Coated surface condition” indicates the condition of the coated surface examined visually.

As seen from FIGS. 4 and 5, when the grooves are not spiral but ring-shaped, the coating solution cannot be moved in the transverse direction, so the occurrence of streaks uniformly spaced could not be prevented (see Nos. 15, 19, 24, 31, 36, and 43).

In addition, when the groove angle α was less than 20 degrees (see Nos. 1 to 9), the occurrence of streaks could not be prevented although the coating speed was varied. When the groove angle α was greater than 70 degrees (see Nos. 49 to 54), the occurrence of nonuniform coating could not be prevented although the coating speed was varied. In contrast, when the groove angle was 20 degrees to 70 degrees (both inclusive), an inhibitory effect on the occurrence of streaks was seen and the occurrence of nonuniform coating could be reduced. However, even if the groove angle was 20 degrees to 70 degrees (both inclusive), when the rate of the smooth portions was less than 0.2 (see Nos. 10, 17, 25, 32, 37, 44, 49, and 55) and 0.7 or more (see Nos. 16, 23, 30, 42, 48, and 54), streaks uniformly spaced occurred or nonuniform coating occurred in the form of streaks. For these reasons, the rate of the smooth portions is preferably 0.2 or more and less than 0.7. In other words, it is preferable that the bar have a groove angle of 20 degrees to 70 degrees (both inclusive) and that the rate of the smooth portions be 0.2 or more and less than 0.7. By doing so, the occurrence of streaks can be prevented and coated surface condition with high precision can be obtained.

What is claimed is:

1. A coating method for applying coating solution to a material to be coated comprising:
feeding the coating solution on an entry side of a traveling material relative to an approximately cylindrical bar;
forcibly providing a flow in a transverse direction of the traveling material to the coating solution when the coating solution passes from the entry side of the traveling material to an exit side relative to the bar;
coating the traveling material with the coating solution by bringing the bar into contact with the traveling material.

2. The coating method according to claim 1, further comprising
rotating the bar so as to feed the coating solution around the bar.

3. The coating method according to claim 1, wherein
the flow of the coating solution in the transverse direction is given by spiral grooves formed on a surface of the bar,
the spiral grooves are inclined at an angle of 20 degrees or more and 70 degrees or less with respect to a plane orthogonal to a central axis of the bar, and
the traveling material comes into contact with smooth portions of the bar excluding the spiral grooves at a percentage of 20% or more.

4. The coating method according to claim 3, further comprising
rotating the bar so as to feed the coating solution around the bar.

5. A coating device comprising:
an approximately cylindrical bar arranged to come into contact with a traveling material to be coated;
a feed device which feeds coating solution to an entry side of the traveling material relative to the bar; and
channels formed on a surface of the bar for dividing the coating solution fed to the entry side of the traveling material into smaller portions in the transverse direction of the traveling material and letting the portions flow through the channels.

6. The coating device according to claim 5, further comprising:
spiral grooves formed on the surface of the bar, as the channels, inclined at an angle of 20 degrees or more and 70 degrees or less with respect to a plane orthogonal to a central axis of the bar; and
smooth portions formed on the surface of the bar, with which the traveling material comes into contact at a percentage of 20% or more.
